(19) United States
(12) Patent Application Publication
(10) Pub. No.: US 2023/0245300 A1
(43) Pub. Date: Aug. 3, 2023

(54) Preoperative Assessment of Bowel Cleansing Adequacy in Colonoscopy

(71) Applicant: Charles Accurso, Hillsborough, NJ (US)

(72) Inventor: Charles Accurso, Hillsborough, NJ (US)

(21) Appl. No.: 17/588,263

(22) Filed: Jan. 29, 2022

(51) Int. Cl. G06T 7/00; G06T 7/11

(52) U.S. Cl. CPC G06T 7/0012; G06T 7/11; G06T 2207/30028; G06T 2207/10024

(57) ABSTRACT

A method of analyzing stool material captured during a preoperative bowel cleansing preparation to assess the adequacy of said preoperative bowel cleansing by color-comparison with a known specimen.

### CROSS-REFERENCES

None.

### BACKGROUND OF THE INVENTION

### Field of the Invention

This invention relates to the field of colonoscopy and colorectal surgery. More particularly, the invention pertains generally to analyzing stool material to assess the adequacy of preoperative bowel cleansing necessary for a successful procedure in an accurate and precise, yet cost-effective manner.

### Background Prior Art

Clinical research has shown that early detection of colorectal cancer (CRC) is a high clinical priority. A colon examination has been shown to be useful in detecting early cancer or premalignant polyps. Patients who are undergoing this diagnostic examinations of the large bowel usually undergo preparation to assure that the bowel is cleansed of all fecal material adequately before the procedure.

Preoperative colon procedure preparation is time consuming and uncomfortable. The prior art does not couple preoperative colon procedure preparation with preoperative colon procedure preparation assessment. Moreover, this cleaning procedure is normally unsupervised. This lack of supervision results in widely varying efficacy.

Practitioners agree that colonoscopy detects neoplasms at the highest rate and simultaneously affords the opportunity for their endoscopic removal. Currently the cleaning procedures associated with this procedure include the combination of reduced food intake with laxatives, enemas, suppositories, bowel evacuants, or retrograde colonic lavage.

Typically, preparation instructions for a colonoscopy include: Two days before, continue eating only low-fiber foods; one day before, go on a clear-liquid diet; and the evening before, drink a prescription laxative to clean out your colon for the procedure. A normal bowel cleansing regiment can take up to 16 hours.

These colonoscopy preparations can be difficult and associated with a number of complications, such as inability to finish the prep, nausea, dehydration and lack of sleep. Importantly there is currently no clear system to assess whether the prep worked as intended, in the preoperative time period.

In particular, conventional techniques are only effective in cleaning the colon for colonoscopy in 85% of patients because patients have not way of assessing whether the prep did its job. When the preparation results in suboptimal cleansing a repeat procedure is typically necessary and the colonoscopy procedure is not as accurate, and possibly miss cancer.

After a proper bowel preparation the stool turns from solid, to liquid to brown liquid to a yellow clear liquid. If there is any residual cloudiness the bowel prep is not complete.

There is therefore a need for a standardized method for assessing the acceptability of a bowel preparation regimen.

Failure to employ preoperative colon procedure preparation assessment results in significant number of poor preparations at colonoscopies. For example, data gleamed from the medical literature, found that using a standard, preoperation colon procedure preparation assessment, 15% of colon procedure preparation were unacceptable. The American Gastroenterological Association suggests that adequate bowel preparation rates should not be lower than 85%. Literature supports that about 15% of colonoscopies are inadequate due to poor preparation. The present invention is able to be reduced the rate of unacceptable colon procedures due to poor preparation to less than 1%.

More than 11 million colonoscopies are performed yearly in the us. Although a number of methods are used to assess the adequacy of bowel preparation during colonoscopy, none is available to assess the adequacy of the bowel preparation prior to performance of colonoscopy. The present invention meets this unmet need.

### Prior Art

The Boston bowel preparation scale (BBPS), a 10-point scale that assesses the adequacy of the bowel preparation DURING the performance of a colonoscopy procedure. The BBPS is insufficient for the purposes of the present invention because it is a retrospective method applied after a colonoscopy is finished. And it fails to consider the multiplicity of camera equipment and visual perception. More specifically, the present invention employs a lighter hue than the BBPS3333 as a recommendation in order to predict the desired degree of bowel cleansing with at least 95% confidence.

Some prior art requires a chemical reaction to produce colors suitable for testing (such as use of a test strip), whereas the present invention does not. U.S. patent Publ. Ser. No. 12/807,912 by Stephan L. Chen et al. Method and Apparatus for Performing Color Based Reaction Testing of Biological Materials, is an example of such a requirement.

U.S. Pat. Publ. No. 2012/0071764A by Anna N. Yaroslaysky et al. discloses a Device and method for wide-field and high-resolution imaging of tissue. Yaroslaysky's method requires two lenses or image sensors arranged at a specific orientation and special software for digital analysis of tissue. While an optional method of using the present invention includes computerized automation, no specific photographic or computer equipment is required.

Australian standard patent appl. no. AU 2019203346 B2 by Daniel Gareau for Optical Detection of Skin Disease has a similar limitation. An optical system for detecting skin disease such as melanoma by evaluating the color resulting from light projected on the skin. The present invention requires no light source or similar tool.

### SUMMARY AND BACKGROUND OF THE INVENTION

The present invention is a method of analyzing pictures of stool material captured during a bowel cleansing preparation to assess the adequacy of the bowel cleansing regimen, preoperatively.

An assessment is performed by color-comparison of an image of a stool sample with a known specimen. The assessment may be performed visually or with digital automation.

The initial embodiment of the present invention comprised the following steps:

Patient verbally instructed to send photo of last bowel movement via the Internet to an email address which was made known to said patient at the time of scheduling procedure.

Patient given written instructions which state “Your exam is only as good as your colon prep. A good sign that the prep has been effective is the transition to clear yellow movements. If, 2 hours prior to your start time, your bowel movements are not clear/yellow (that is, they are still solid or mostly brown), please call for instructions.” Said instruction included photos of adequate vs. inadequate bowel movement (see FIG. 1—a color photo).

On the day the patient is scheduled for a procedure, the patient is asked to send a photo of last bowel movement via the Internet to an email address which was made known to said patient at the time of scheduling procedure.

Upon receipt of said photo of last bowel movement sent via the Internet to an email address which was made known to said patient at the time of scheduling procedure, said photo of last bowel movement is examined by a medical professional.

Said medical professional assesses said photo of last bowel movement to determine if said photo discloses an adequate preparation or not.

If adequate, then the patient is informed that no further preparation is necessary.

If inadequate, patient is informed that the preparation is inadequate and further instructions are given for the patient to continue the preparation until the proper color and clarity of the stool is reached, and documented by additional photos.

Upon the receipt of subsequent photos, said medical professional executes a second assessment to determine if said photo discloses an adequate preparation or not.

If said second assessment is found to be adequate, then the patient is informed by said medical professional that no further preparation is necessary received

If said second assessment is found inadequate, then the patient is informed by said medical professional to continue the preparation with additional enemas, until the appropriate color of stool is noted.

If the patient is unable to complete the prep at home or self-administer further prep, they are asked to come early to ASC so the staff of the ASC can administer further enemas and prep to the patient

All photos noted above are printed and placed in patient's chart.

All photos are scanned into an electronic medical record with the rest of the chart paperwork and saved.

While this embodiment of the present invention results in the reduction of the rate of unacceptable colon procedure preparation to less than 1% from the normal rate of 15%, a degree of judgment is required by the medial professional assessing the photo of the bowel movement.

The one percent error may be further reduced by giving the medial professional a tool to better assess the photo taken by the patient. Said tool may be a color chart (see FIG. 2) or a color assessment computer aid.

A number of color assessment computer aids are available. One example is Camtasia which is a software suite for creating images published by TechSmith. Camtasia can be used to match the color of photo with specific callout colors. In the case of the present invention the callout color (i.e. the color needed to be matched) is a color from the color chart.

Camtasia (as a color matching element of the current invention) would be used as follows: The photo of last bowel movement by the patient which was sent via the Internet to an email address which was made know to said patient at the time of scheduling procedure is copied from the receiving e-mail and designated as the color to be matched. Select the eyedropper tool and click the desired color (i.e. the color of the last bowel movement by the patient). To match the selected item (i.e. the desired color which is the color of the last bowel movement) to a particular color in the image (i.e. the color chart able to identify acceptable colored bowel movement photo), open the color picker and click the eyedropper icon.

The cursor changes to an eyedropper. As it is dragged across the image of the color chart, the eyedropper displays the color it is currently hovering above, along with the associated hexadecimal (HEX) color value.

Once the designed color has the same HEX color value of a color on the color chart a match is displayed. Said match is either acceptable or unacceptable base on a HEX color value equal to or lighter than #ffffe0. #ffffe0 is a light yellow with a very light shade of yellow-green.

### BRIEF DESCRIPTION OF THE DRAWINGS

FIG. 1 is a photo sent to a patient with procedure instructions

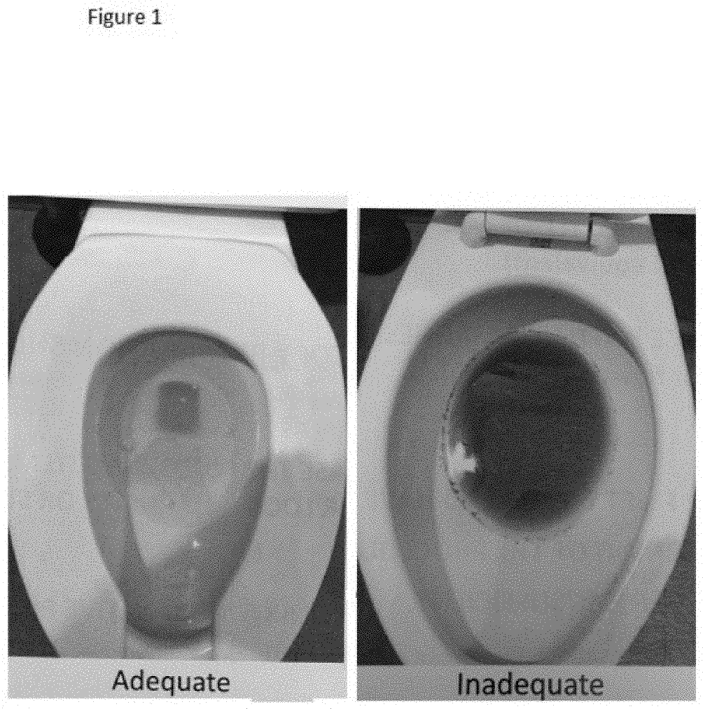

FIG. 2 is a color chart

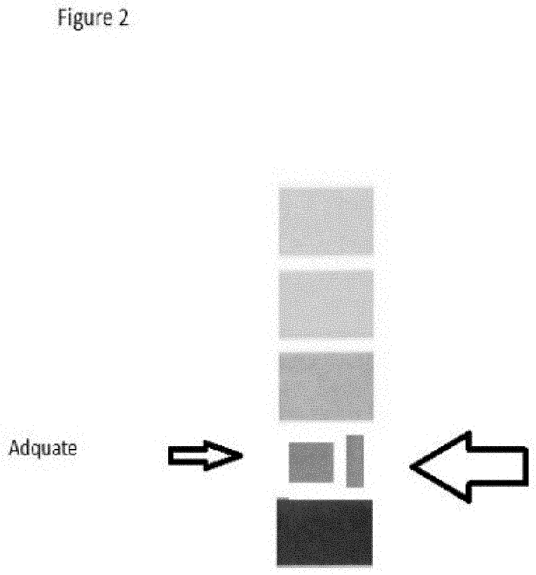

### DETAILED DESCRIPTION OF THE INVENTION

The present invention is a method for color-based assessment of a preoperative colon procedure preparation, comprising the acts or steps:
a. executing said preoperative colon procedure preparation,
b. obtaining a stool sample,
c. capturing a first image of said stool sample,
d. locating a second image having color data from a resource storing a range of stool color information,
e. comparing said first image with said second image for color equivalency,
f. evaluating said comparison with a resource corresponding to each of a plurality of stool colors, said image data information having color information matching color information
g. generating test results based on said matching.

The present invention is a result of extensive, two-phased experimentation. This first phase was a determination of the color of a photograph of the patient's bowel movement sufficient to achieve a high degree of confidence that that said patient's bowel movement was indicative of an adequate bowel cleansing.

Furthermore, to arrive at the color standard of the present invention which is used to educate the patient or the color used to assess photographs sent by the patient, clarity in addition to color was considered. A number of experiments were conducted similar or equivalent to the following to achieve a consistent outcome. More particularly in order to develop the color/clarity standard a number of different concentrations of stool and liquid aspirated during routine colonoscopies were compared to each other. Post operatively the Boston Scale was used to assess postoperative bowel preparation.

More specifically, the predictive result related to the adequacy preparation of the present invention were compared to the actual adequacy from postoperative assessment of the condition of the bowel during the medical procedure using the Boston Bowl Preparation scale.

Clarity in photographic equipment is required to adjust the color images so as to more accurately reflect the item being photographed. In addition to a typical 256-color palette, a transparency specification is employed. An example of such a transparency specification is a GIF89a (graphics interchange format version 89a). A trial of various clarity standards was also required to properly select the color image. Photographs sent by a patient affix the color and clarity for each photograph as metadata. The color standard imposed by the present invention integrates clarity with color without need for a separate clarity standard.

The present invention benefits from significant experiment using black and white photos of the bowel preparation, adjusting shades and density. Black-and-white images were found not to result in a statistically significant improvement of bowel preparation. Different concentration of stool in the post preparation liquid lead to darker colors. Only when a specific yellow color or lighter color was achieved by the patient preoperatively, did the inventor determine there was a significant drop in repeat colonoscopy procedures.

The second phase was the use of an educational and motivational program which would result in a statistically significant improvement in the preoperative assessment of bowel-cleaning adequacy. In addition, staff education of the patient making the cleansing preparation, and comparing their last bowel movement with the yellow color above, led to statistically significant improvements in bowel preparation and successful colonoscopies. This education comprises in-person and telephone communications which both stressed the need to achieve the desired color in the patient's photograph as in the reference image provided at the time of scheduling or pre-procedure consultation. The results from this process were compared with sending photographs and instructions to patients which was statistically as effective, which result was nonobvious.

More specifically, an experiment was conducted involving 30 patients who were instructed on the necessity to reach the color of stool prior to leaving their home, a statistically significant increase in successful colonoscopies to 99% was achieved.

Stool color analysis is well documented and understood. For example, normal stool color is brown. If stool is black or clay-colored, maroon, or red, it is generally agreed that a medical problem is leading to this. The color of stool due to preoperative preparations is also known. A medical professional is normally able to assess when a stool sample indicates a bowel is relatively adequately prepared for the operative procedure.

The prior art is not helpful for the present invention because camera sensors do not have the same spectral response as human eyes. The standards noted in the prior art have a stool-color standard denoting adequacy of preoperative cleansing did not consider the variations introduced by variables such as bowl tint, camera lens, rim lighting, and other factors.

The reference color provided to a patient could be adjusted to consider the variation in color perception in an individual patient. Reference colors may need to be exaggerated or lightened, for example, to compensate for the lab-color standard for determining adequacy may be adjusted to account for the color-perception or other visual impairments of the patent to achieve said 95% confidence.

In nearly every case, there are sensors that respond to red, green, and blue, but the human-eye response is very different from that of camera sensors. The present invention depends on camera sensors from a wide variety of photographic equipment; consequently, the present invention required the discovery of a stool-standard color which may be used to educate the patient and evaluate photographs sent by said patient. Generally, the experimentation necessary to identify said color standard was achieved in the following manner.

The photograph's color which results in a high degree of confidence that the preoperative assessment of bowel-cleaning was adequate, differs between the actual color in situ and the color captured by a photographic representation thereof. Such differences result from, including, the tint of the bowl, lighting conditions, the particular sensor in the camera or mobile phone. Experimentation was performed to compensate for said differences in the transmitted images. Said experimentation was necessary to achieve at least a 95% confidence that images were adequate based on at least 100 random images of stool samples. In particular, an experiment was conducted wherein more than 100 random images of stool-sample photographs sent by patients were analyzed. Colors selected as the standard for the invention represented the color wherein at least 95% of the assessments were adequate when compared to reference photographs.

Using a subject patient who has performed a preparation protocol, a photograph is taken and transmitted of a stool sample left in a bowl. Then a medical professional made a visual assessment for adequacy. From the photograph of the sample, the color was selected and hypothesize that said color indicates adequate cleansing. Another 100 photographs of stool-sample colors were compared to develop a proprietary standard to make the assessment whether the pre-procedure cleansing was adequate or inadequate.

Then the notes of the professional performing the actual colonoscopy on the subject were examined for whether the colon presented as having been adequately cleansed during the preoperative protocol. This process was repeated, comparing reference photographs to select reference colors that are at least 95% predictive in practice.

Various other modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate embodiments also can be implemented in combination in a single embodiment. Conversely, various features that are described in the context of a single embodiment also can be implemented in multiple embodiments separately or in any suitable sub-combination.

Moreover, although features may be described above as acting in certain combinations and even initially claimed as such, one or more features from a claimed combination can in some cases be excised from the combination, and the claimed combination may be directed to a sub-combination or variation of a sub-combination.

I claim:

1. A method for preoperative assessment of bowel cleansing adequacy for a preoperative colon procedure, comprising the acts of
a. providing education to a patient at time of scheduling said preoperative colon procedure,
wherein said education comprises of desired stool color from photographs of stool receptacles showing acceptable and unacceptable colors,
wherein said acceptable stool color is one of the following: lighter than a light yellow having a very light shade of yellow-green; lighter than HEX color value #FFFFE0, and HEX #FFFFE0;
b. obtaining a stool sample,
c. capturing a first image of said stool sample,
d. locating a second image having color data from a resource storing said acceptable stool color,
wherein said acceptable stool color is one of the following: lighter than a light yellow having a very light shade of yellow-green; lighter than HEX color value #FFFFE0, and HEX #FFFFE0;
e. comparing said first image with said second image for color equivalency,
f. evaluating said comparison with a resource corresponding to each of a plurality of stool colors, said image data information having color information matching color information
g. generating test results based on said comparison for professional assessment.

2. The method of claim 1, wherein comparing said first image with said second image is performed digitally.

3. The method of claim 1, wherein said step of evaluation is based on an automatic evaluation of said acceptable stool color being one of the following: lighter than a light yellow having a very light shade of yellow-green; lighter than HEX color value #FFFFE0, and HEX #FFFFE0.

4. A method of analyzing stool material captured during a preoperative bowel cleansing preparation to assess the adequacy of a cleanse, said method comprising the steps of
(a) scheduling a colonoscopic procedure with a patient,
(b) providing said patient with an electronic mail address,
(c) instructing said patient said preoperative bowel cleansing preparation necessary for success of said colonoscopic procedure,
(d) instructing said patient said stood material must at least one of clear and yellowish approximately two hours prior to said colonoscopic procedure,
(e) on day of said colonoscopic procedure instructing said patient to make an image of said stood material,
(f) transmitting said image by patient via internet to said electronic mail address,
(g) receipt of said image,
(h) forwarding said image to a medical professional,
(i) comparing said image with a reference specimen by said medical professional,
(j) determining adequacy of said preoperative bowel cleansing preparation disclosed by said image,
(k) advising said patient results of said preoperative bowel cleansing preparation,
(l) if said image discloses inadequacy of said preoperative bowel cleansing preparation,
(m) instructing said patient to perform additional preparation prior to said colonoscopic procedure;
(n) Repeating said additional preparation as needed.

5. The method of claim 4 further including the step of administration of at least one enema by said medical professional at place of said colonoscopic procedure.

6. The method of claim 4 wherein the step of comparing said image with said reference specimen is performed with a digital computer.

7. The method of claim 4 wherein the step of comparing said image with said reference specimen is performed using Camtasia software.
